(19) United States
(12) Patent Application Publication
(10) Pub. No.: US 2025/0091747 A1
(43) Pub. Date: Mar. 20, 2025

(54) APPARATUS AND METHOD FOR REMOVING CAP WITH SWAB FROM CONTAINER

(71) Applicant: ILLUMINA, INC., San Diego, CA (US)

(72) Inventor: Jessica PARKER, San Diego, CA (US)

(21) Appl. No.: 18/830,699

(22) Filed: Sep. 11, 2024

Related U.S. Application Data
(60) Provisional application No. 63/538,299, filed on Sep. 14, 2023.

(51) Int. Cl. B65B 43/00; A45D 34/04

(52) U.S. Cl. CPC B65B 43/00; A45D 34/042

(57) ABSTRACT

An apparatus includes a vial engagement assembly, a cap engagement assembly, and a processor. The processor activates relative movement along a first dimension between the cap engagement assembly and a vial positioned in a stage of the vial engagement assembly to engage a cap engagement head with a cap secured to the vial. A rotary shaft is rotated about a first rotation axis to remove the cap from the vial via the cap engagement head. The processor then activates relative movement along a second dimension between the cap engagement assembly and the vial to provide deformation of a swab head of a swab shaft extending from the cap. The swab head deforms against an inner sidewall of the vial. The rotary shaft further rotates to rotate the cap, swab shaft, and swab head via the cap engagement head while the swab head deforms against the inner sidewall of the vial.

### BACKGROUND

In some scenarios, it may be necessary to transport a fluid-containing container (e.g., vial, tube, etc.) from a fluid collection site to a fluid analysis site. The container may include a cap to seal the fluid inside the container during storage and transport. At the fluid analysis site, the cap may be removed to access the fluid within the container for analysis of the fluid. An example of a context in which fluid is collected at one site and analyzed at another site is DNA testing, where a sample fluid containing DNA is collected from a human, pet, or other source, and then sent to a testing site for analysis of the DNA in the fluid. In some cases, a swab may be used to obtain the sample fluid containing DNA. The swab may be included in the container with the fluid during storage and transport to the fluid analysis site.

While a variety of devices, systems, and methods have been made and used to extract fluid from a container, it is believed that no one prior to the inventor(s) has made or used the devices and techniques described herein.

### BRIEF DESCRIPTION OF THE DRAWINGS

FIG. 1 depicts a perspective view of an example of a fluid container assembly.

FIG. 2 depicts an exploded perspective view of the fluid container assembly of FIG. 1, where a cap assembly is separated from a vial.

FIG. 3 depicts a perspective view of an example of a cap removal system.

FIG. 4 depicts another perspective view of the cap removal system of FIG. 3, with some components omitted to reveal a vial engagement assembly.

FIG. 5 depicts a perspective view of a cap engagement assembly of the cap removal system of FIG. 3.

FIG. 6 depicts an exploded perspective view of the cap engagement assembly of FIG. 5.

FIG. 7 depicts a perspective view of a lead-in ring of the cap engagement assembly of FIG. 5.

FIG. 8 depicts a cross-sectional view of the lead-in ring of FIG. 7, taken along line 8-8 of FIG. 7.

FIG. 9 depicts a perspective view of an engagement head of the cap engagement assembly of FIG. 5.

FIG. 10 depicts an end view of the engagement head of FIG. 9.

FIG. 11A depicts a schematic view of a first stage of an example of operation of the cap removal system of FIG. 3, with the fluid container assembly of FIG. 1 before engagement by the cap engagement assembly of FIG. 5.

FIG. 11B depicts a schematic view of a second stage of an example of operation of the cap removal system of FIG. 3, with the cap engagement assembly of FIG. 5 advanced along a z-direction to engage the cap assembly of FIG. 2.

FIG. 11C depicts a schematic view of a third stage of an example of operation of the cap removal system of FIG. 3, with the cap engagement assembly of FIG. 5 rotating about the z-axis in a first angular direction to unscrew the cap assembly of FIG. 2 from the vial of FIG. 2.

FIG. 11D depicts a schematic view of a fourth stage of an example of operation of the cap removal system of FIG. 3, with the cap engagement assembly of FIG. 5 moving the cap assembly of FIG. 2 away from the vial of FIG. 2 along the z-direction.

FIG. 11E depicts a schematic view of a fifth stage of an example of operation of the cap removal system of FIG. 3, with the vial engagement assembly moving the vial of FIG. 2 from a first position to a second position along the x-direction, and with the cap engagement assembly of FIG. 5 tilting about the y-axis.

FIG. 11F depicts a schematic view of a sixth stage of an example of operation of the cap removal system of FIG. 3, with the cap engagement assembly of FIG. 5 rotating the cap assembly of FIG. 2 in the first angular direction about a tilted axis relative to the vial of FIG. 2 while the vial of FIG. 2 remains at the second position along the x-direction.

FIG. 11G depicts a schematic view of a seventh stage of an example of operation of the cap removal system of FIG. 3, with the vial engagement assembly moving the vial of FIG. 2 from the second position to a third position along the x-direction, and with the cap engagement assembly of FIG. 5 rotating the cap assembly of FIG. 2 in the first angular direction about a tilted axis relative to the vial of FIG. 2.

FIG. 11H depicts a schematic view of an eighth stage of an example of operation of the cap removal system of FIG. 3, with the vial engagement assembly moving the vial of FIG. 2 from a the third position to the second position along the x-direction, and with the cap engagement assembly of FIG. 5 still tilting about the y-axis.

FIG. 11I depicts a schematic view of a ninth stage of an example of operation of the cap removal system of FIG. 3, with the cap engagement assembly of FIG. 5 rotating the cap assembly of FIG. 2 in a second angular direction about a tilted axis relative to the vial of FIG. 2 while the vial of FIG. 2 remains at the second position along the x-direction.

FIG. 11J depicts a schematic view of a tenth stage of an example of operation of the cap removal system of FIG. 3, with the vial engagement assembly moving the vial of FIG. 2 from the second position to the third position along the x-direction, and with the cap engagement assembly of FIG. 5 rotating the cap assembly of FIG. 2 in the second angular direction about a tilted axis relative to the vial of FIG. 2.

FIG. 11K depicts a schematic view of an eleventh stage of an example of operation of the cap removal system of FIG. 3, with the vial engagement assembly moving the vial of FIG. 2 from the second position to the first position, and with the cap engagement assembly of FIG. 5 axially aligned with the vial.

FIG. 11L depicts a schematic view of a twelfth stage of an example of operation of the cap removal system of FIG. 3, with the cap assembly of FIG. 2 fully removed from the vial of FIG. 2.

### DETAILED DESCRIPTION

The following detailed description of certain examples will be better understood when read in conjunction with the appended drawings. To the extent that the figures illustrate diagrams of the functional blocks of various examples, the functional blocks are not necessarily indicative of the division between hardware components. Thus, for example, one or more of the functional blocks (e.g., processors or memories) may be implemented in a single piece of hardware (e.g., a general purpose signal processor or random access memory, hard disk, or the like). Similarly, the programs may be stand-alone programs, may be incorporated as subroutines in an operating system, may be functions in an installed software package, and the like. It should be understood that the various examples are not limited to the arrangements and instrumentality shown in the drawings.

### I. Example of Fluid Sample Container With Swab

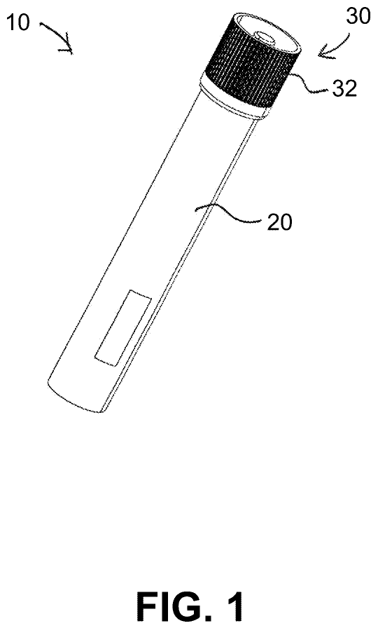

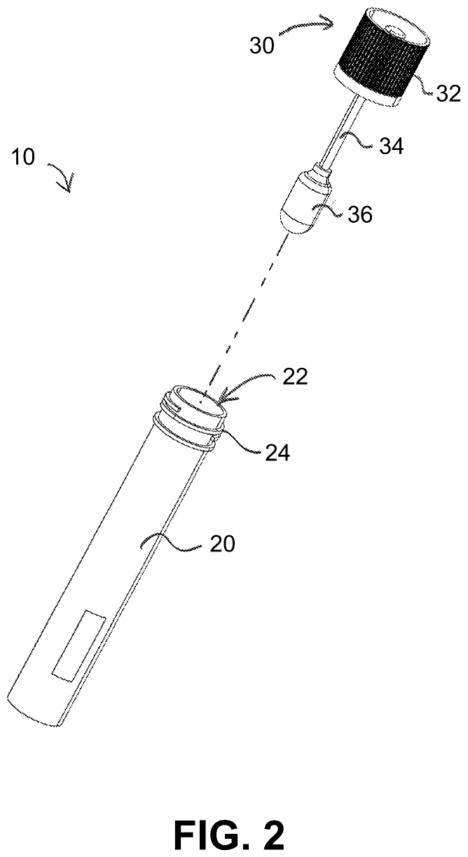

As noted above, there may be scenarios where fluid is collected at one site and then sent to another site for analysis, where the fluid may be stored and transported in a container with a lid. As also noted above, in some such scenarios, a swab may be used to obtain the sample fluid; and the swab may be included in the container. FIGS. 1-2 show an example of a fluid container assembly (10) that may be used in this fashion. Fluid container assembly (10) of this example includes a vial (20) with a cap assembly (30). Vial (20) has a tubular configuration in this example, though vial (20) may alternatively have any other suitable configuration. Vial (20) defines a hollow interior (22) that is configured to receive and contain fluid. Threading (24) is provided at the open end of vial (20) for securing cap assembly (30) to vial (20).

Cap assembly (30) of the present example includes a cap (32), a shaft (34), and a swab head (36). Cap (32) is configured to be secured to vial (20) via threading (24) at the open end of vial (20). Shaft (34) extends integrally from cap (32), such that shaft (34) is attached to cap (32) in this example. Shaft (34) comprises a flexible material that allows shaft (34) to bend laterally as will be described in greater detail below. Swab head (36) is secured to the free end of shaft (34). Swab head (36) comprises biological collection region that may be an absorbent or non-absorbent material, such that swab head (36) may be pressed against the inside of a cheek, be pressed against mucosal tissue in the nasal cavity, or be otherwise manipulated in any other suitable fashion in any other suitable site to collect a sample fluid. By way of example only, swab head (36) may be swept along the inside of mouth or nasal passage of a dog or other pet to collect a fluid sample for subsequent DNA testing. In some cases, tissue fragments and/or other solid materials may be picked up by swab head (36) in addition to, or in lieu of, swab head (36) picking up fluid. Other suitable ways in which swab head (36) may be used will be apparent to those skilled in the art in view of the teachings herein.

Once fluid is collected via swab head (36), swab head (36) and shaft (34) may be inserted into hollow interior (22) of vial (20); and cap (32) may be secured to vial (20) via threading (24). In some scenarios, a buffer solution or other fluid is already present in hollow interior (22) of vial (20), and at least a portion of swab head (36) is disposed in that fluid when cap assembly (30) is secured to vial (20). Various suitable compositions that may be used to provide such a buffer solution or other fluid within hollow interior (22) of vial (20) will be apparent to those skilled in the art in view of the teachings herein. Regardless of whether a buffer solution or other fluid is already within hollow interior (22) of vial (20) when swab head (36) and shaft (34) are inserted into hollow interior (22) of vial (20), cap (32) and vial (20) cooperate to provide a fluid-tight seal and thereby contain any fluid and/or other material collected by swab head (36) until the fluid is ready for testing.

### II. Example of Cap Removal System

When a fluid-containing container like fluid container assembly (10) reaches a fluid testing site, it may become necessary to remove cap assembly (30) from vial (20) to access the fluid contained within hollow interior (22) of vial (20). While cap assembly (30) may theoretically be removed from vial (20) by a human operator, such manual operation may be impractical in scenarios where a substantial number of vials (20) need to be processed in a relatively short time. It may therefore be desirable to provide an automated system that is operable to quickly remove cap assemblies (30) from a substantial number of vials (20) in a relatively short time. Such an automated system may facilitate rapid testing of a substantial number of fluid samples from different sources.

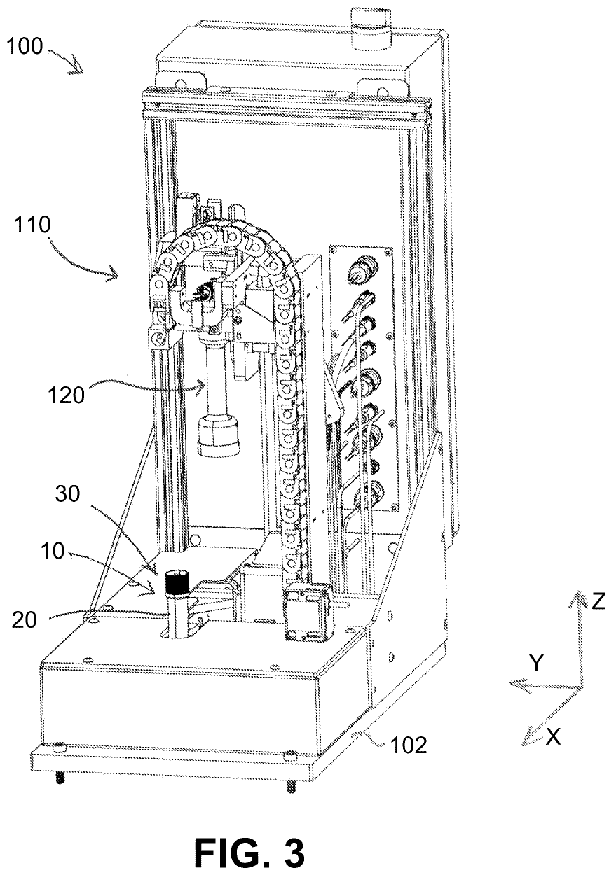

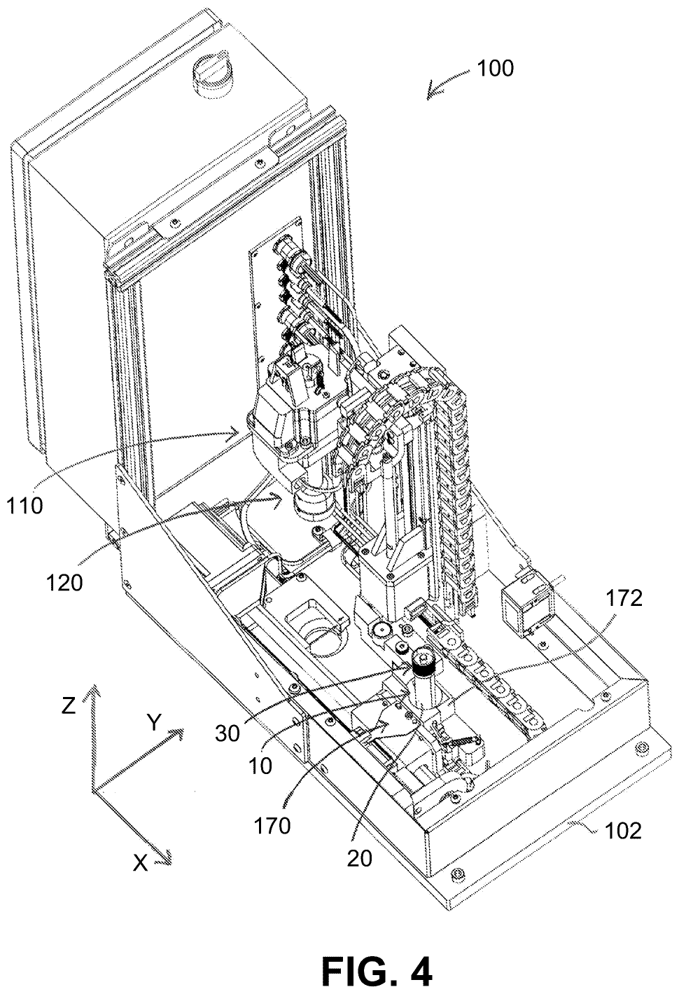

In scenarios where a fluid container assembly consisting of simple vial and a simple cap, without a swab, is used, it may be relatively easy to automate the removal of the cap for subsequent extraction of fluid from the vial for testing. For instance, an automated cap removal system may simply remove the cap, dispose of the cap, and transition the vial to another station for removal (e.g., pipetting, etc.) of the fluid from the vial. However, the process may be substantially more complicated in scenarios where a fluid container assembly like fluid container assembly (10) is used. The complication may be due, in part, to the fact that swab head (36) may contain some fluid due to the biological material retention properties of swab head (36). In other words, if an automated cap removal system were to simply remove cap assembly (30) from vial (20), dispose of cap assembly (30), and transition vial (20) to another station for removal (e.g., pipetting, etc.) of whatever fluid remains in vial (20), at least some otherwise potentially useful fluid may be disposed of with swab head (36). It may therefore be desirable to provide a cap removal system that is operable to extract biological material from swab head (36), with the extracted biological material remaining in vial (20), as part of the process of removing cap assembly (30) from vial (20). FIGS. 3-4 show an example of a cap removal system (100) that is capable of achieving this.

Cap removal system (100) of the present example includes a first drive assembly (110), a cap engagement assembly (120), and a vial engagement assembly (170). These components (110, 120, 170) are all supported on a base (102), which may be placed on a benchtop, within a larger fluid processing system, or otherwise positioned. Cap engagement assembly (120) is operable to engage cap (32) of cap assembly (30), as will be described in greater detail below.

First drive assembly (110) is operable to drive movement of cap engagement assembly (120) in the z-dimension. First drive assembly (110) is also operable to drive pivotal movement of cap engagement assembly (120) about the y-axis; and drive rotation of cap engagement assembly (120) about a central longitudinal axis defined by cap engagement assembly (120) (even when cap engagement assembly (120) is pivoted about the y-axis). By way of example only, first drive assembly (110) may comprise one or more motors, solenoids, hydraulic actuators, pneumatic actuators, and/or various other components as will be apparent to those skilled in the art in view of the teachings herein.

Vial engagement assembly (170) is operable to receive and firmly grip vial (20). Vial engagement assembly (170) includes a stage (172) that is operable to move vial along the x-dimension. In some versions, vial engagement assembly (170) includes a clamping feature, suction feature, and/or other kind of feature that is configured to releasably grip vial (20) during the various stages of operation as described below; then release vial (20) to allow vial (20) to be removed from cap removal system (100) for subsequent extraction of fluid from vial (20) after completion of the various stages of operation as described below. By way of example only, vial engagement assembly (170) may comprise one or more motors, solenoids, hydraulic actuators, pneumatic actuators, and/or various other components as will be apparent to those skilled in the art in view of the teachings herein. It should also be understood that one or more robotic arms and/or other kind(s) of automated feature(s) may be utilized to insert vial (20) into vial engagement assembly (170) and then remove vial (20) from vial engagement assembly (170), to further facilitate rapid processing of a substantial number of fluid container assemblies (10) by cap removal system (100).

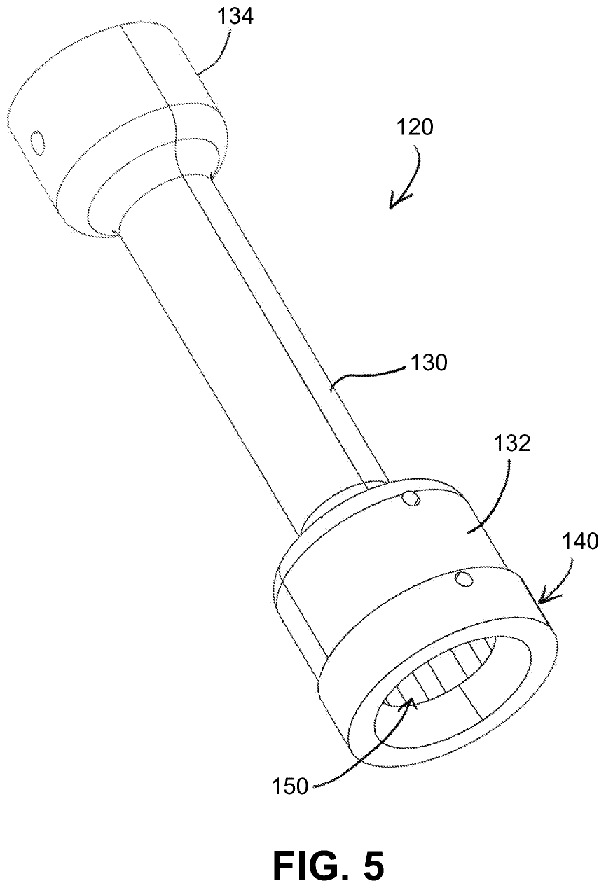

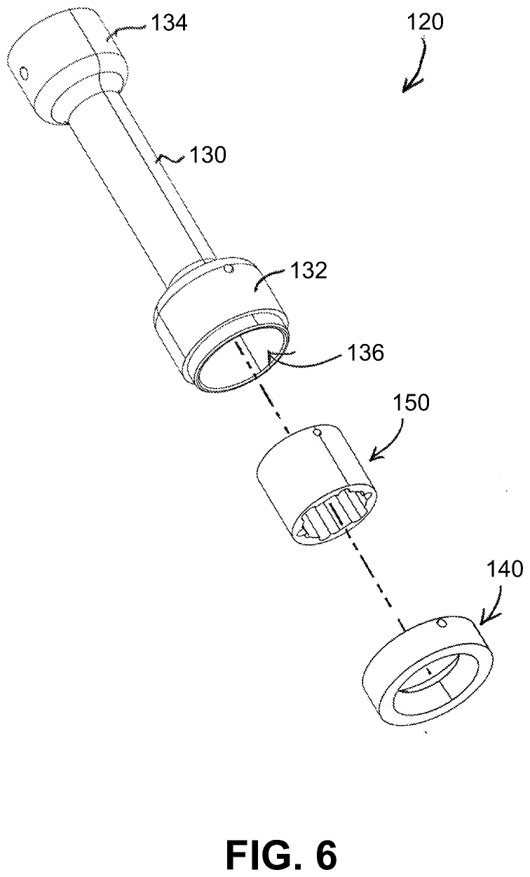

FIGS. 5-10 show various components of cap engagement assembly (120) in greater detail. As shown, cap engagement assembly (120) includes a shaft (130), a lead-in ring (140), and an engagement head (150). Shaft (130) has a proximal end (134) and a distal end (132). Proximal end (134) is coupled with first drive assembly (110), such that first drive assembly (110) is operable to drive movement of cap engagement assembly (120) via proximal end (134). Shaft (120) thus provides a rotary drive spindle. Distal end (132) defines a hollow interior (136). Engagement head (150) is disposed within hollow interior (136), with lead-in ring (140) being positioned distally in relation to engagement head (150).

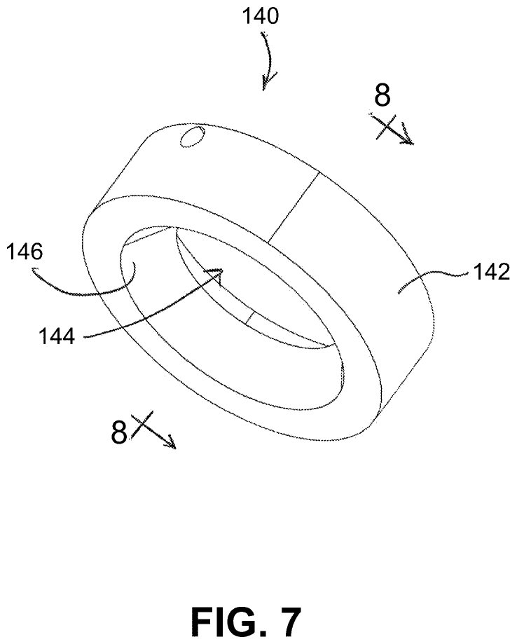

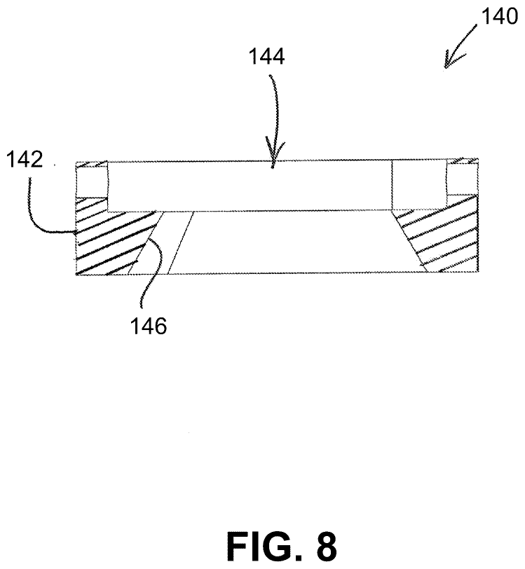

As best seen in FIGS. 7-8, lead-in ring (140) of this example includes an annular body (142) that defines a central opening (144) with a distally-facing lead-in surface (146). Central opening (144) is sized to receive cap (32), while lead-in surface (146) defines a taper that is configured to facilitate entry of cap (32) into central opening (144). In some versions, lead-in ring (140) also assists in retaining engagement head (150) within hollow interior (136) at distal end (132) of shaft (130). In the present example, lead-in ring (140) is fixedly secured to distal end (132) of shaft (130), distal to engagement head (150).

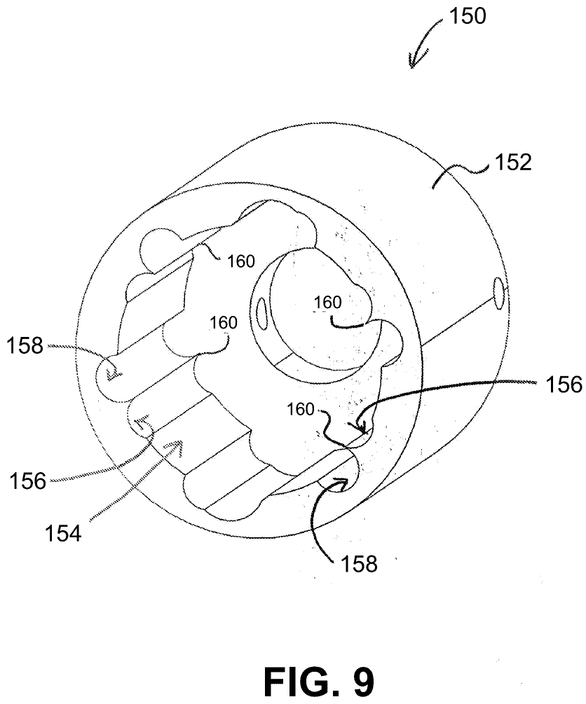

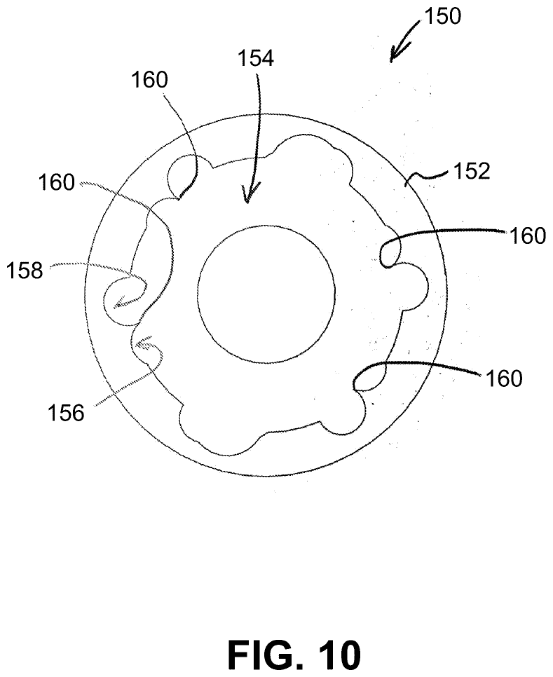

As best seen in FIGS. 9-10, engagement head (150) of the present example includes a cylindraceous body (152) that defines a distally facing recess (154). Recess (154) is radially bound by a surface that defines a plurality of concave recess (156, 158) pairs. Each recess (156, 158) is in the form of a scallop, with each recess (158) being radially deeper than each recess (156). Each pair of concave recesses (156, 158) forms a radially inwardly oriented edge (160) that extends along the longitudinal length of recess (154). In the present example, engagement head (150) includes four edges (160) and four corresponding pairs of concave recesses (156, 158). Alternatively, other variations of engagement head (150) may provide more or fewer than four edges (160); and more or fewer than four corresponding pairs of concave recesses (156, 158).

The configuration and arrangement of recesses (156, 158) and edges (160) may provide a beneficial relationship between engagement head (150) and cap (32). In particular, the configuration and arrangement of recesses (156, 158) and edges (160) may allow engagement head (150) to slide down onto cap (32) along the z-direction, such that cap (32) is received in distally facing recess (154), without requiring any component of engagement head (150) to move relative to another component of engagement head (150). Moreover, the configuration and arrangement of recesses (156, 158) and edges (160) may allow engagement head (150) to achieve sufficient angular grip on cap (32) to allow engagement head (150) to rotate cap (32); again without requiring any component of engagement head (150) to move relative to another component of engagement head (150). Such an angular grip of cap (32) may be achieved, at least in part, by edges (160) cutting or “biting” into the material forming cap (32) or otherwise deforming the material forming cap (32).

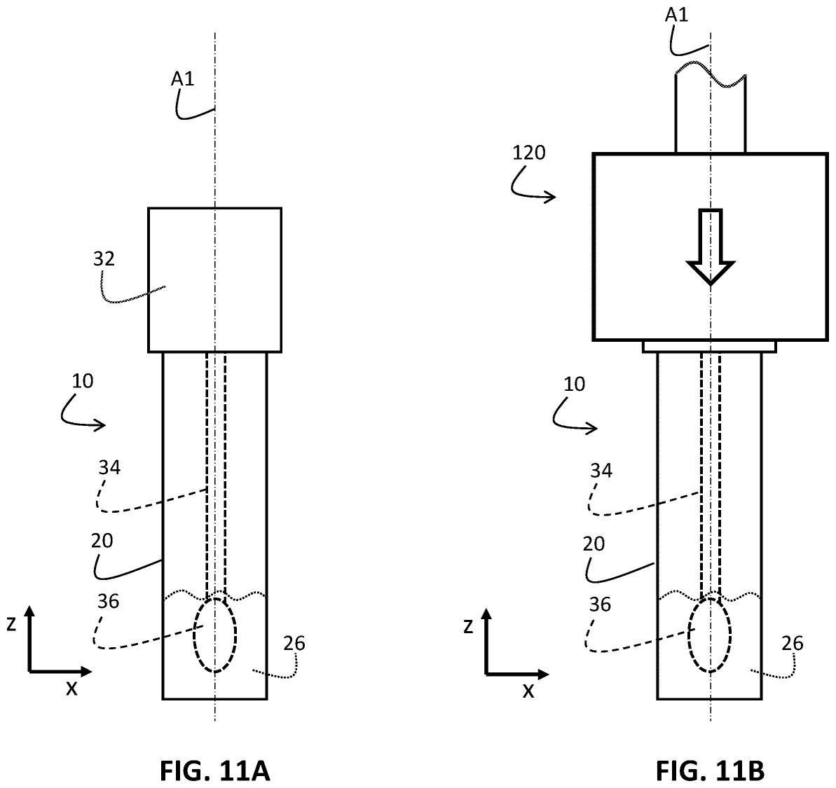

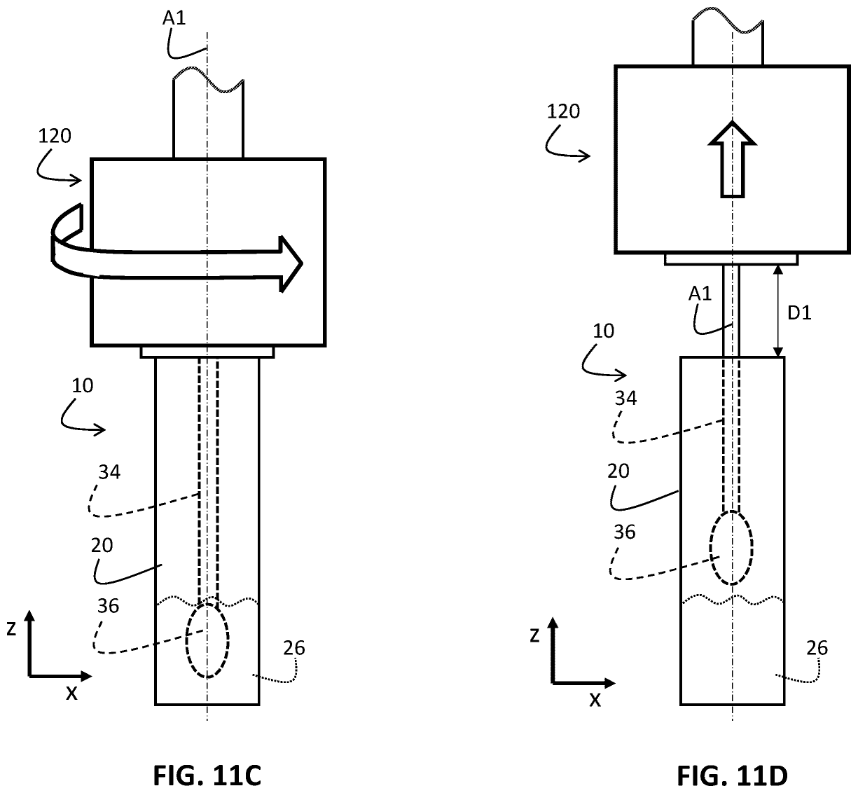

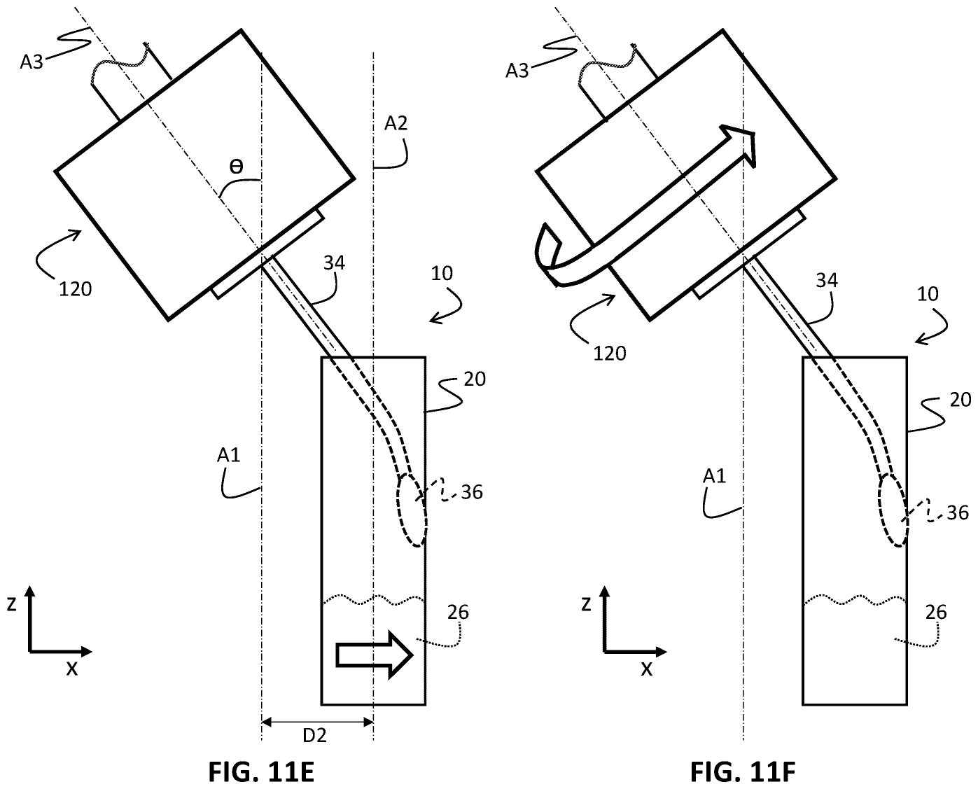

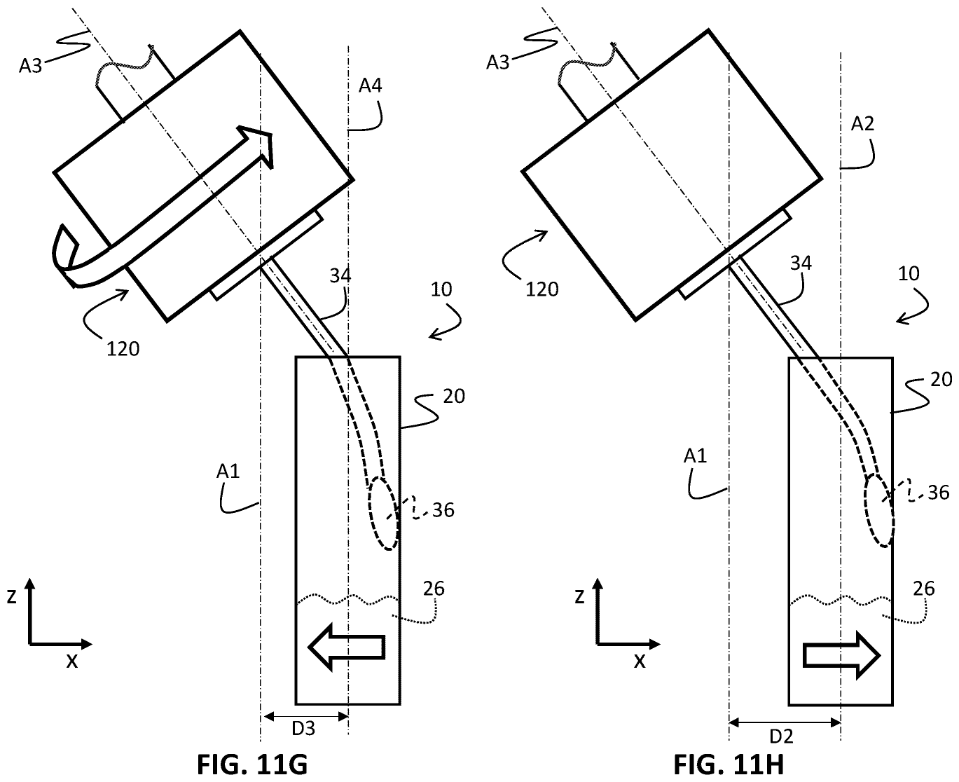

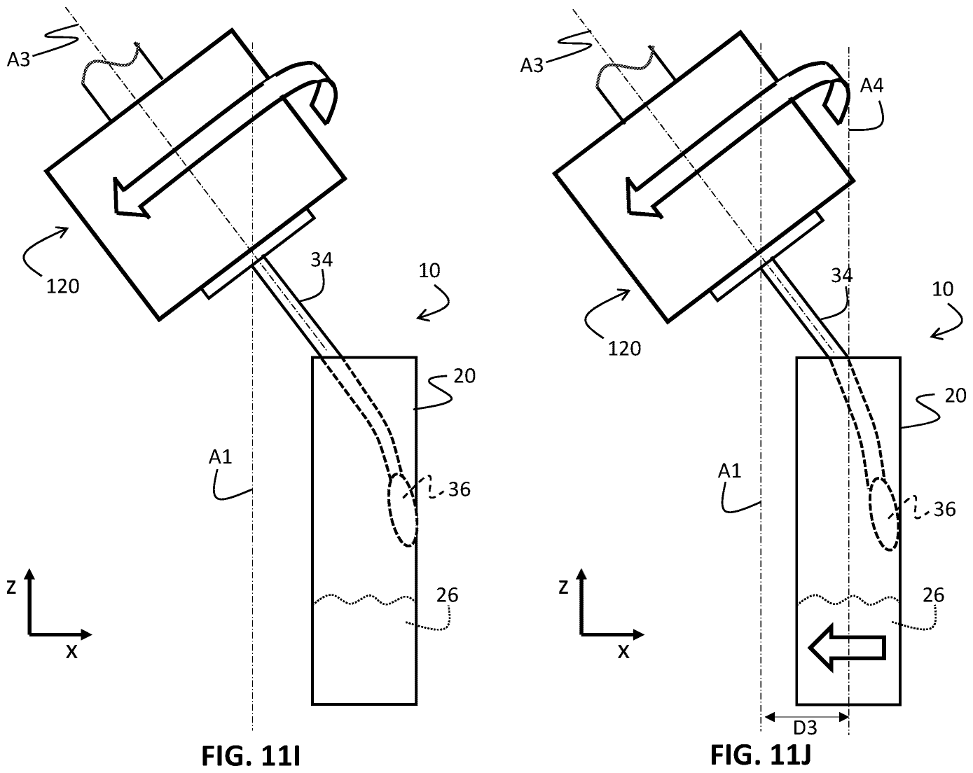

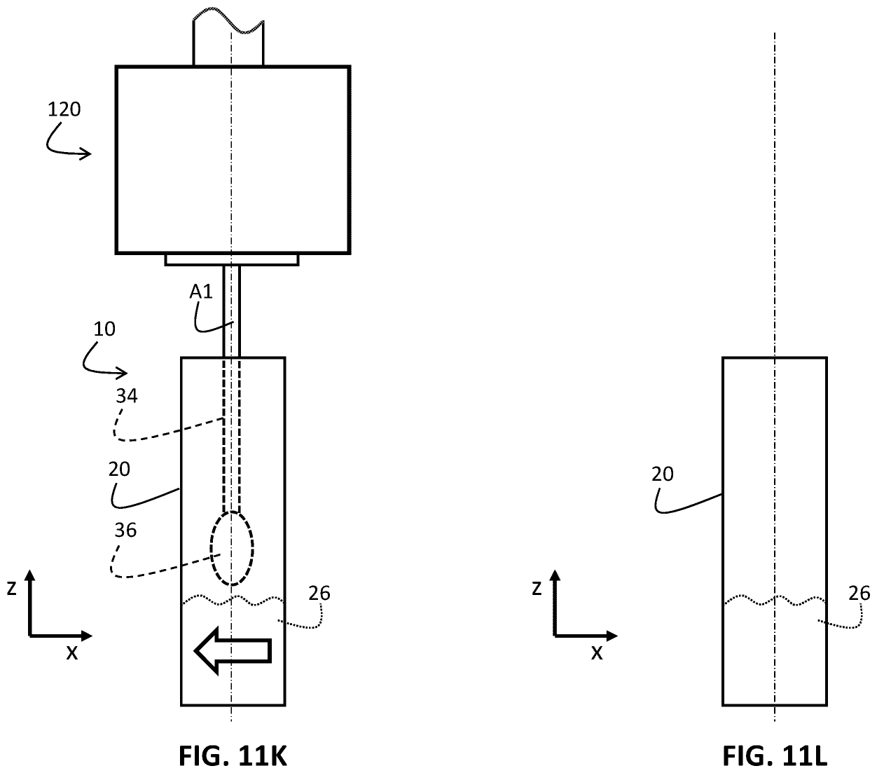

Engagement head (150) of this example consists of a single, monolithic, homogenous continuum of rigid material, such that engagement head (150) does not have any components that move relative to each other. This may substantially simplify the construction and operation of engagement head (150), particularly as compared to a “chuck” type of cap engagement feature that includes one or more components that move relative to each other to selectively engage and disengage a cap. Despite these potential benefits of the configuration of engagement head (150) described above, some other variations of cap removal system (100) may include other kinds of cap engagement features, including but not limited to alternative cap engagement features that include one or more components that move relative to each other to selectively engage and disengage cap (20). Thus, while the method of operation described below with reference to FIGS. 11A-11L may benefit from the configuration and operability of engagement head (150) as described above, the method of operation described below with reference to FIGS. 11A-11L is not limited to being carried out with versions of cap removal system (100) that include engagement head (150) as described above. In one example, a movable clamping mechanism may be used to accommodate caps of different sizes. Further, multiple and/or interchangeable monolithic chucks may be employed to accommodate caps of different sizes.

### III. Example of Method of Operating Cap Removal System

FIGS. 11A-11L depict various stages in an example of how cap removal system (100) may be operated in connection with fluid container assembly (10), though it should be understood that there may be other methods through which cap removal system (100) may be operated in connection with fluid container assembly (10). While vial engagement assembly (170) is not shown in FIGS. 11A-11L, it should be understood that fluid container assembly (10) may be firmly seated in vial engagement assembly (170) throughout the stages of operation shown in FIGS. 11A-11L. It should also be understood that a robotic arm or other automated device may be used to place fluid container assembly (10) in vial engagement assembly (170) before performance of the stages of operation shown in FIGS. 11A-11L. Alternatively, a human operator may manually place fluid container assembly (10) in vial engagement assembly (170) before performance of the stages of operation shown in FIGS. 11A-11L.

As shown in FIG. 11A, the method of the present example begins with fluid container assembly (10) initially positioned along a first axis (A1), which is parallel with the z-axis. A fluid (26) is contained within vial (20); and swab head (36) is at least partially disposed in fluid (26). Next, first drive assembly (110) is activated to drive cap engagement assembly (120) downwardly along the z-dimension, along the first axis (A1), such that cap (32) is received in distally facing recess (154) of engagement head (150) as shown in FIG. 11B. As noted above, lead-in surface (146) of lead-in ring (140) may assist with entry of cap (32) into distally facing recess (154) during the transition from the stage of operation shown in FIG. 11A to the stage of operation shown in FIG. 11B.

With cap (32) received in distally facing recess (154) of engagement head (150), first drive assembly (110) is activated to drive cap engagement assembly (120) to rotate in a first angular direction about the first axis (A1) as shown in FIG. 11C. Vial engagement assembly (170) maintains a firm grip on vial (20) while first drive assembly (110) rotates cap engagement assembly (120) about the first axis (A1). As first drive assembly (110) rotates cap engagement assembly (120) about the first axis (A1), edges (160) in distally facing recess (154) of engagement head (150) “bite” into cap (32) as described above, such that cap engagement assembly (120) rotates cap (32) relative to vial (20). This causes cap (32) to unscrew from threading (24).

With cap (32) unscrewed from threading (24), drive assembly (110) is activated to drive cap engagement assembly (120) upwardly along the z-dimension, along the first axis (A1), to separate cap (32) from vial (20) by a first distance (D1) as shown in FIG. 11D, this separation leads to swab head (36) no longer being disposed in fluid (26). The first distance (D1) may have any other suitable value.

After drive assembly (110) and cap engagement assembly (120) have pulled swab head (36) from fluid (26), vial engagement assembly (170) is activated to drive vial (20) in a first direction along the x-dimension by a second distance (D2), as shown in FIG. 11E. By way of example only, this second distance (D2) may range from approximately 50 mm to approximately 80 mm; or more particularly the second distance (D2) may be approximately 77 mm. Alternatively, the second distance (D2) may have any other suitable value.

At this stage, vial (20) is centered along a second axis (A2), which is parallel with the first axis (A1) and is separated from the first axis (A1) by the second distance (D2). In addition, drive assembly (110) is activated to drive pivotal movement of cap engagement assembly (120) about the y-axis, such that cap engagement assembly (120) is oriented along a third axis (A3). Third axis (A3) defines an oblique angle (θ) with first axis (A1). By way of example only, this oblique angle (θ) may range from approximately 15 degrees to approximately 45 degrees. Alternatively, oblique angle (θ) may have any other suitable value.

In some versions, first drive assembly (110) also drives movement of cap engagement assembly (120) downwardly in the z-dimension right before reaching the stage shown in FIG. 11E, during the transition from the stage shown in FIG. 11D to the stage shown in FIG. 11E, or right after reaching the stage shown in FIG. 11E (but before reaching the stage shown in FIG. 11F). By way of example only, distance of this downward movement may be approximately 40 mm. Alternatively, cap engagement assembly (120) may move downwardly in the z-dimension along any other suitable distance right before reaching the stage shown in FIG. 11E, during the transition from the stage shown in FIG. 11D to the stage shown in FIG. 11E, or right after reaching the stage shown in FIG. 11E (but before reaching the stage shown in FIG. 11F). In still other variations, cap engagement assembly (120) simply does not move downwardly in the z-dimension right before reaching the stage shown in FIG. 11E, during the transition from the stage shown in FIG. 11D to the stage shown in FIG. 11E, or right after reaching the stage shown in FIG. 11E.

With cap engagement assembly (120) being oriented obliquely relative to vial (20), with cap (32) being effectively secured within cap engagement assembly (120), and with shaft (34) being secured to cap (32), the upper portion of shaft (34) is oriented obliquely relative to vial (20) at the stage of operation shown in FIG. 11E. This causes a lower portion of shaft (34) to deform within vial (20). Shaft (34) of the present example is resiliently biased to assume a straight configuration, such that the deformed shaft (34) resiliently urges swab head (36) against the inner sidewall of vial (20). This pressing of swab head (36) against the inner sidewall of vial (20) may in turn deform swab head (36) and thereby cause at least some biological material to be forced from swab head (36), with such biological material accumulating within fluid (26) that is already disposed at the bottom of vial (20).

With deformed shaft (34) resiliently urging swab head (36) against the inner sidewall of vial (20), drive assembly (110) is activated to drive rotational movement of cap engagement assembly (120) in the first angular direction about the third axis (A3), as shown in FIG. 11F. This in turn causes swab head (36) to rotate against the inner sidewall of vial (20) while shaft (34) resiliently urges swab head (36) against the inner sidewall of vial (20). This combination of pressing against the inner sidewall of vial (20) and rotating against the inner sidewall of vial (20) may cause additional biological material to be forced from swab head (36), with such additional biological material accumulating within fluid (26) that is already disposed at the bottom of vial (20).

By way of example only, drive assembly (110) may drive rotational movement of cap engagement assembly (120) in the first angular direction in the arrangement shown in FIG. 11F at a rate ranging from approximately 80 rpm to approximately 660 rpm; or more particularly at a rate of approximately 300 rpm. Alternatively, any other suitable rate of rotation may be provided during the stage shown in FIG. 11F. By way of further example only, drive assembly (110) may maintain rotational movement of cap engagement assembly (120) in the first angular direction about the third axis (A3) in the arrangement shown in FIG. 11F for a duration ranging from approximately 1seconds to approximately 4 seconds; or more particularly a duration of approximately 1.5 seconds. Alternatively, any other suitable rotation duration may be provided during the stage shown in FIG. 11F.

Next, vial engagement assembly (170) is activated to drive vial (20) in a second direction along the x-dimension to center vial (20) along a fourth axis (A4), which is parallel with the first axis (A1) and is separated from the first axis (A1) by a third distance (D3), as shown in FIG. 11G. By way of example only, this third distance (D3) may range from approximately 50 mm to approximately 80 mm; or more particularly the third distance (D3) may be approximately 67 mm. Alternatively, the third distance (D3) may have any other suitable value.

In some versions, first drive assembly (110) also drives movement of cap engagement assembly (120) upwardly in the z-dimension right before reaching the stage shown in FIG. 11G, during the transition from the stage shown in FIG. 11F to the stage shown in FIG. 11G, or right after reaching the stage shown in FIG. 11G (but before reaching the stage shown in FIG. 11H). By way of example only, distance of this upward movement may be approximately 10 mm. Alternatively, cap engagement assembly (120) may move upwardly in the z-dimension along any other suitable distance right before reaching the stage shown in FIG. 11G, during the transition from the stage shown in FIG. 11F to the stage shown in FIG. 11G, or right after reaching the stage shown in FIG. 11G (but before reaching the stage shown in FIG. 11H). In still other variations, cap engagement assembly (120) simply does not move upwardly in the z-dimension right before reaching the stage shown in FIG. 11G, during the transition from the stage shown in FIG. 11F to the stage shown in FIG. 11G, or right after reaching the stage shown in FIG. 11G.

In some variations, drive assembly (110) ceases rotational movement of cap engagement assembly (120) in the first angular direction about the third axis (A3) as vial engagement assembly (170) moves vial (20) from the second axis (A2) (FIG. 11F) to the fourth axis (A4) (FIG. 11G); and then begins rotational movement of cap engagement assembly (120) in the first angular direction about the third axis (A3) again after vial (20) is centered along the fourth axis (A4). In the present example, however, drive assembly (110) maintains rotational movement of cap engagement assembly (120) in the first angular direction about the third axis (A3) as vial engagement assembly (170) moves vial (20) from the second axis (A2) (FIG. 11F) to the fourth axis (A4) (FIG. 11G).

The degree of deformation of shaft (34) may be increased in the stage shown in FIG. 11G relative to the deformation of shaft (34) during the stage shown in FIG. 11F, which may increase the force with which swab head (36) bears against the inner sidewall of vial (20). In addition, the different degrees of deformation of shaft (34) in the stage shown in FIG. 11G versus the stage shown in FIG. 11F may cause different regions of swab tip (36) to be pressed against the inner sidewall of vial (20). In other words, the different positioning of vial (20) during the stage shown in FIG. 11G relative to the positioning of vial (20) during the stage shown in FIG. 11F may provide extraction of fluid from a region of swab tip (36) from which fluid was not being extracted during the stage shown in FIG. 11F. Ultimately, the continued combination of pressing against the inner sidewall of vial (20) and rotating against the inner sidewall of vial (20) during the stage shown in FIG. 11G may cause additional biological material to be forced from swab head (36), with such additional biological material accumulating within fluid (26) that is already disposed at the bottom of vial (20).

By way of example only, drive assembly (110) may drive rotational movement of cap engagement assembly (120) in the first angular direction in the arrangement shown in FIG. 11G at a rate ranging from approximately 80 rpm to approximately 660 rpm; or more particularly at a rate of approximately 300 rpm. Alternatively, any other suitable rate of rotation may be provided during the stage shown in FIG. 11G. Drive assembly (110) maintains rotational movement of cap engagement assembly (120) in the first angular direction about the third axis (A3) for a certain period of time after vial (20) reaches alignment with the fourth axis (A4) as shown in FIG. 11G. By way of example only, drive assembly (110) may maintain rotational movement of cap engagement assembly (120) in the first angular direction about the third axis (A3) in the arrangement shown in FIG. 11G for a duration ranging from approximately 1 seconds to approximately 4 seconds; or more particularly a duration of approximately 1.5 seconds. Alternatively, any other suitable rotation duration may be provided during the stage shown in FIG. 11G.

Next, vial engagement assembly (170) is activated to drive vial (20) in the first direction along the x-dimension to once again center vial (20) along the second axis (A2), as shown in FIG. 11H. In the example shown, drive assembly (110) ceases rotation of cap engagement assembly (120) about the third axis (A3) right before or during the transition of vial (20) from the position shown in FIG. 11G to the position shown in FIG. 11H. In some other versions, drive assembly (110) continues rotation of cap engagement assembly (120) in the first angular direction about the third axis (A3) right before or during the transition of vial (20) from the position shown in FIG. 11G to the position shown in FIG. 11H. As yet another variation, drive assembly (110) may reverse rotation of cap engagement assembly (120), before or during the transition of vial (20) from the position shown in FIG. 11G to the position shown in FIG. 11H, such that drive assembly (110) drives rotation of cap engagement assembly (120) in a second angular direction about the third axis (A3) right before or during the transition of vial (20) from the position shown in FIG. 11G to the position shown in FIG. 11H.

In some versions, first drive assembly (110) also drives movement of cap engagement assembly (120) downwardly in the z-dimension right before reaching the stage shown in FIG. 11H, during the transition from the stage shown in FIG. 11G to the stage shown in FIG. 11H, or right after reaching the stage shown in FIG. 11H (but before reaching the stage shown in FIG. 11I). By way of example only, distance of this downward movement may be approximately 10 mm. Alternatively, cap engagement assembly (120) may move downwardly in the z-dimension along any other suitable distance right before reaching the stage shown in FIG. 11H, during the transition from the stage shown in FIG. 11G to the stage shown in FIG. 11H, or right after reaching the stage shown in FIG. 11H (but before reaching the stage shown in FIG. 11I). In still other variations, cap engagement assembly (120) simply does not move downwardly in the z-dimension right before reaching the stage shown in FIG. 11H, during the transition from the stage shown in FIG. 11G to the stage shown in FIG. 11H, or right after reaching the stage shown in FIG. 11H.

Regardless of whether rotation of cap engagement assembly (120) continues rotation, ceases rotation, or reverses rotation before and/or during the transition of vial (20) from the position shown in FIG. 11G to the position shown in FIG. 11H, drive assembly (110) drives rotation of cap engagement assembly (120) in the second angular direction about the third axis (A3) after vial (20) has reached the position shown in FIG. 11H. This rotation of cap engagement assembly (120) in the second angular direction about the third axis (A3) is shown in FIG. 11I. It should be understood that the stage of operation shown in FIG. 11I is substantially similar to the stage of operation shown in FIG. 11F, except that the direction of rotation of drive assembly (110) and cap assembly (30) has been reversed. This reversal of the direction of rotation of drive assembly (110) and cap assembly (30) my promote further extraction of biological material from swab head (36) (as compared to a scenario where swab head (36) is only rotated in one single angular direction while bearing against the inner sidewall of vial (20)).

By way of example only, drive assembly (110) may drive rotational movement of cap engagement assembly (120) in the second angular direction in the arrangement shown in FIG. 11I at a rate ranging from approximately 80 rpm to approximately 660 rpm; or more particularly at a rate of approximately 300 rpm. Alternatively, any other suitable rate of rotation may be provided during the stage shown in FIG. 11I. By way of further example only, drive assembly (110) may maintain rotational movement of cap engagement assembly (120) in the second angular direction about the third axis (A3) in the arrangement shown in FIG. 11I for a duration ranging from approximately 1 seconds to approximately 4 seconds; or more particularly a duration of approximately 1.5 seconds. Alternatively, any other suitable rotation duration may be provided during the stage shown in FIG. 11I.

Next, vial engagement assembly (170) is activated to drive vial (20) in the second direction along the x-dimension to center vial (20) again along the fourth axis (A4), as shown in FIG. 11J. In some variations, drive assembly (110) ceases rotational movement of cap engagement assembly (120) in the second angular direction about the third axis (A3) as vial engagement assembly (170) moves vial (20) from the second axis (A2) (FIG. 11I) to the fourth axis (A4) (FIG. 11J); and then begins rotational movement of cap engagement assembly (120) in the second angular direction about the third axis (A3) again after vial (20) is centered along the fourth axis (A4). In the present example, however, drive assembly (110) maintains rotational movement of cap engagement assembly (120) in the second angular direction about the third axis (A3) as vial engagement assembly (170) moves vial (20) from the second axis (A2) (FIG. 11I) to the fourth axis (A4) (FIG. 11J).

In some versions, first drive assembly (110) also drives movement of cap engagement assembly (120) upwardly in the z-dimension right before reaching the stage shown in FIG. 11J, during the transition from the stage shown in FIG. 11I to the stage shown in FIG. 11J, or right after reaching the stage shown in FIG. 11J (but before reaching the stage shown in FIG. 11K). By way of example only, distance of this upward movement may be approximately 10 mm. Alternatively, cap engagement assembly (120) may move upwardly in the z-dimension along any other suitable distance right before reaching the stage shown in FIG. 11J, during the transition from the stage shown in FIG. 11I to the stage shown in FIG. 11J, or right after reaching the stage shown in FIG. 11J (but before reaching the stage shown in FIG. 11K). In still other variations, cap engagement assembly (120) simply does not move upwardly in the z-dimension right before reaching the stage shown in FIG. 11J, during the transition from the stage shown in FIG. 11I to the stage shown in FIG. 11J, or right after reaching the stage shown in FIG. 11J.

As described above, the degree of deformation of shaft (34) may be increased in the stage shown in FIG. 11J relative to the deformation of shaft (34) during the stage shown in FIG. 11I, which may increase the force with which swab head (36) bears against the inner sidewall of vial (20). In addition, the different degrees of deformation of shaft (34) in the stage shown in FIG. 11J versus the stage shown in FIG. 11I may cause different regions of swab tip (36) to be pressed against the inner sidewall of vial (20). In other words, the different positioning of vial (20) during the stage shown in FIG. 11J relative to the positioning of vial (20) during the stage shown in FIG. 11I may provide extraction of fluid from a region of swab tip (36) from which fluid was not being extracted during the stage shown in FIG. 11F. Ultimately, the continued combination of pressing against the inner sidewall of vial (20) and rotating against the inner sidewall of vial (20) during the stage shown in FIG. 11J may cause additional biological material to be forced from swab head (36), with such additional biological material accumulating within fluid (26) that is already disposed at the bottom of vial (20).

Drive assembly (110) maintains rotational movement of cap engagement assembly (120) in the second angular direction about the third axis (A3) for a certain period of time after vial (20) reaches alignment with the fourth axis (A4) as shown in FIG. 11J. By way of example only, drive assembly (110) may drive rotational movement of cap engagement assembly (120) in the second angular direction in the arrangement shown in FIG. 11J at a rate ranging from approximately 80 rpm to approximately 660 rpm; or more particularly at a rate of approximately 300 rpm. Alternatively, any other suitable rate of rotation may be provided during the stage shown in FIG. 11J. By way of further example only, drive assembly (110) may maintain rotational movement of cap engagement assembly (120) in the second angular direction about the third axis (A3) in the arrangement shown in FIG. 11J for a duration ranging from approximately 1seconds to approximately 4 seconds; or more particularly a duration of approximately 1.5 seconds. Alternatively, any other suitable rotation duration may be provided during the stage shown in FIG. 11J.

As shown in FIG. 11K, rotation of cap engagement assembly (120) and cap assembly (30) eventually ceases, and vial engagement assembly (170) is activated to drive vial (20) in the second direction along the x-dimension to center vial (20) again along the first axis (A1). In addition, drive assembly (110) is activated to drive pivotal movement of cap engagement assembly (120) about the y-axis, such that cap engagement assembly (120) is again oriented along the first axis (A1). Cap engagement assembly (120), cap assembly (30), and vial (20) thus return to respective positions similar to those shown in FIG. 11D and described above. However, at the stage shown in FIG. 11K, at least a substantial portion of the biological material that was previously in swab tip (36) (e.g., at the stage shown in FIG. 11D) has been forced from swab tip (36) and is now accumulated with fluid (26) in the bottom of vial (20).

With at least a substantial portion of the fluid that was previously in swab tip (36) now accumulated with fluid (26) in the bottom of vial (20), cap assembly (130) may be disposed of, leaving behind vial (20) containing fluid (26) as shown in FIG. 11L. Cap assembly (130) may be disposed of in various ways. By way of example only, a robotic arm or other device may retrieve cap assembly (130) from cap engagement assembly (120) and then dispose of cap assembly (130) in a waste bin or other receptacle. As another example, cap engagement assembly (120) may include one or more features that are operable to eject cap assembly (130) from cap engagement assembly (120) into a waste bin or other receptacle. As yet another example, a human operator may manually remove cap assembly (130) from cap engagement assembly (120) and then dispose of cap assembly (130) in a waste bin or other receptacle. Alternatively, cap assembly (130) may be disposed of in any other suitable fashion after reaching the stage of operation shown in FIG. 11L.

It should also be understood that vial (20) containing fluid (26) may be handled in numerous different ways after reaching the stage of operation shown in FIG. 11L. By way of example only, a robotic arm or other device may retrieve vial (20) from vial engagement assembly (170) and then reposition vial (20) in some other station (e.g., a pipetting station, etc.) for extraction of fluid (26) from vial (20) for analysis or other handling. As another example, a human operator may retrieve vial (20) from vial engagement assembly (170) and then reposition vial (20) in some other station (e.g., a pipetting station, etc.) for extraction of fluid (26) from vial (20) for analysis or other handling. In some cases, vial engagement assembly (170) drives movement of vial (20) along the x-dimension to increase the space between vial (20) and cap engagement assembly (120) after reaching the stage of operation shown in FIG. 11L, thereby facilitating removal of vial (20) from vial engagement assembly (170). Alternatively, vial (20) may be handled in any other suitable fashion after reaching the stage of operation shown in FIG. 11L. Regardless of how vial (20) is removed from vial engagement assembly (170), another fluid container assembly (10) may be subsequently positioned in vial engagement assembly (170), and the above-described process may be carried out again with this subsequent fluid container assembly (10).

In the example described above with reference to FIGS. 11A-11L, vial engagement assembly (170) drives movement of vial (20) along the x-dimension to cause swab head (36) to deformably bear against the inner sidewall of vial (20). In other words, while cap engagement assembly (120) moves along the z-dimension and pivots about the y-axis, cap engagement assembly (120) does not otherwise move along the x-dimension. In some other variations, vial (20) remains stationary along the x-dimension while cap engagement assembly (120) moves along the x-dimension to cause swab head (36) to deformably bear against the inner sidewall of vial (20). It should therefore be understood that relative movement between vial (20) and cap engagement assembly (120) along the x-dimension may be provided in numerous ways, such that the relative movement along the x-dimension need not necessarily be provided in the exact fashion as described above with reference to FIGS. 11A-11L.

Similarly, in the example described above with reference to FIGS. 11A-11L, cap engagement assembly (120) moves along the z-dimension while vial (20) remains stationary along the z-dimension to allow cap engagement assembly (120) to provide separation between cap assembly (30) and vial (20). In some other variations, cap engagement assembly (120) remains stationary along the z-dimension while vial (20) moves along the z-dimension to provide separation between cap assembly (30) and vial (20). It should therefore be understood that relative movement between vial (20) and cap engagement assembly (120) along the z-dimension may be provided in numerous ways, such that the relative movement along the z-dimension need not necessarily be provided in the exact fashion as described above with reference to FIGS. 11A-11L.

### IV. Examples of Combinations

The following examples relate to various non-exhaustive ways in which the teachings herein may be combined or applied. The following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

An apparatus, comprising: a vial engagement assembly comprising a stage, the stage to releasably engage a vial; a cap engagement assembly comprising: a rotary shaft, and a cap engagement head, the cap engagement head to engage a cap secured to a vial positioned in the stage of the vial engagement assembly; and a processor, the processor to: activate relative movement along a first dimension between the cap engagement assembly and a vial positioned in the stage of the vial engagement assembly to provide engagement between the cap engagement head and a cap secured to the vial, activate rotation of the rotary shaft about a first rotation axis to remove the cap from the vial via the cap engagement head, activate relative movement along a second dimension between the cap engagement assembly and the vial to provide deformation of a swab head of a swab shaft extending from the cap, the swab head deforming against an inner sidewall of the vial, and further activate rotation of the rotary shaft to rotate the cap, swab shaft, and swab head via the cap engagement head while the swab head deforms against the inner sidewall of the vial.

### Example 2

The apparatus of Example 1, the stage of the vial engagement assembly being movable along the second dimension, the processor to activate relative movement along a second dimension between the cap engagement assembly and the vial by driving movement of the vial engagement assembly along the second dimension.

### Example 3

The apparatus of any of Examples 1 through 2, the cap engagement head lacking any portion cap engagement head that moves relative to any other portion of the cap engagement head.

### Example 4

The apparatus of any of Examples 1 through 3, the cap engagement head including a plurality of edges to engage material of the cap and thereby bite into the cap.

### Example 5

The apparatus of Example 4, the cap engagement head further comprising a plurality of pairs of scalloped recesses, each edge of the cap engagement head being positioned between a respective pair of scalloped recesses.

### Example 6

The apparatus of Example 5, each pair of scalloped recesses comprising a first scalloped recess having a first depth and a second scalloped recess having a second depth, the first depth being greater than the second depth.

### Example 7

The apparatus of any of Examples 4 through 6, the cap engagement head comprising a monolithic piece providing fixed separation between the plurality of edges such that the edges of the plurality of edges are immobile relative to each other.

### Example 8

The apparatus of any of Examples 4 through 7, the edges to slide along the cap during the relative movement between the cap engagement assembly and the vial along the first dimension to provide engagement between the cap engagement head and the cap.

### Example 9

The apparatus of Example 8, the edges further to grip the cap during rotation of the rotary shaft to remove the cap from the vial via the cap engagement head.

### Example 10

The apparatus of any of Examples 8 through 9, the edges further to grip the cap during rotation of the rotary shaft to rotate the cap, swab shaft, and swab head via the cap engagement head while the swab head deforms against the inner sidewall of the vial.

### Example 11

The apparatus of any of Examples 1 through 10, the cap engagement assembly further comprising a lead-in ring having an angled surface to guide the cap into the cap engagement head during the relative movement between the cap engagement assembly and the vial along the first dimension to provide engagement between the cap engagement head and the cap.

### Example 12

The apparatus of any of Examples 1 through 11, the cap engagement assembly further to pivot about a pivot axis, the pivot axis being orthogonal to the first dimension and the second dimension.

### Example 13

The apparatus of Example 12, the cap engagement assembly to pivot about the pivot axis during and after relative movement along the second dimension between the cap engagement assembly and the vial.

### Example 14

The apparatus of Example 13, the rotary shaft to rotate about a second rotation axis to thereby rotate the cap, swab shaft, and swab head via the cap engagement head while the swab head deforms against the inner sidewall of the vial.

### Example 15

The apparatus of Example 14, the second rotation axis being obliquely oriented relative to the first rotation axis.

### Example 16

A method comprising: removing a cap assembly from a vial, the cap assembly comprising a cap, a swab shaft extending integrally from the cap, and a swab head secured to an opposing end of the swab shaft, the act of removing the cap assembly from the vial being performed by a cap engagement assembly of an apparatus; providing separation between the cap assembly and the vial along a first dimension, the swab head remaining within an interior of the vial after the act of providing separation between the cap assembly and the vial along the first dimension, the act of providing separation between the cap assembly and the vial along the first dimension being performed by the apparatus; providing separation between the cap assembly and the vial along a second dimension, the act of providing separation between the cap assembly and the vial along the second dimension resulting in the swab head being pressed against an inner sidewall of the vial, the act of providing separation between the cap assembly and the vial along the second dimension being performed by the apparatus; and activating the cap engagement assembly to rotate the cap assembly about a first axis of rotation while the swab head is pressed against the inner sidewall of the vial.

### Example 17

The method of Example 16, the act of removing the cap assembly from the vial comprising: translating the cap engagement assembly along a second dimension until the cap is received in a cap engagement head of the cap engagement assembly, and rotating the cap engagement assembly to unscrew the cap from the vial.

### Example 18

The method of Example 17, the cap engagement head comprising a plurality of gripping edges that slide along an exterior of the cap during the act of translating the cap engagement assembly along the second dimension.

### Example 19

The method of Example 18, the gripping edges biting into the cap during the act of rotating the cap engagement assembly to unscrew the cap from the vial.

### Example 20

The method of Example 19, the gripping edges maintaining a fixed distance relative to each other throughout performance of the acts of translating the cap engagement assembly along the second dimension until the cap is received in a cap engagement head of the cap engagement assembly and rotating the cap engagement assembly to unscrew the cap from the vial.

### Example 21

The method of any of Examples 16 through 20, the vial being positioned in a stage of a vial engagement assembly, the act of providing separation between the cap assembly and the vial along the first dimension comprising driving movement of the stage along the first dimension relative to the cap engagement assembly.

### Example 22

The method of any of Examples 16 through 21, the cap engagement assembly tilting about a pivot axis during performance of the act of providing separation between the cap assembly and the vial along the first dimension.

### Example 23

The method of Example 22, the act of removing the cap assembly from the vial comprising rotating the cap engagement assembly about a second axis of rotation, the first axis of rotation being obliquely oriented relative to the second axis of rotation.

### Example 24

The method of any of Examples 16 through 23, the act of providing separation between the cap assembly and the vial along the second dimension further resulting in deformation of the swab shaft.

### Example 25

The method of Example 24, the deformed swab shaft resiliently urging the swab head against the inner sidewall of the vial.

### Example 26

The method of any of Examples 16 through 25, the activating the cap engagement assembly to rotate the cap assembly about the first axis of rotation while the swab head is pressed against the inner sidewall of the vial comprising: rotating the cap assembly in a first angular direction about the first axis of rotation while the swab head is pressed against the inner sidewall of the vial, and rotating the cap assembly in a second angular direction about the first axis of rotation while the swab head is pressed against the inner sidewall of the vial.

### Example 27

The method of Example 26, further comprising moving the vial along the first dimension one or more times between performance of the act of rotating the cap assembly in a first angular direction about the first axis of rotation while the swab head is pressed against the inner sidewall of the vial and the act of rotating the cap assembly in a second angular direction about the first axis of rotation while the swab head is pressed against the inner sidewall of the vial.

### Example 28

The method of Example 27, further comprising rotating the cap assembly in the first angular direction about the first axis of rotation while performing the act of moving the vial along the first dimension one or more times between performance of the act of rotating the cap assembly in a first angular direction about the first axis of rotation while the swab head is pressed against the inner sidewall of the vial and the act of rotating the cap assembly in a second angular direction about the first axis of rotation while the swab head is pressed against the inner sidewall of the vial.

### Example 29

The method of any of Examples 27 through 28, further comprising rotating the cap assembly in the second angular direction about the first axis of rotation while performing the act of moving the vial along the first dimension one or more times between performance of the act of rotating the cap assembly in a first angular direction about the first axis of rotation while the swab head is pressed against the inner sidewall of the vial and the act of rotating the cap assembly in a second angular direction about the first axis of rotation while the swab head is pressed against the inner sidewall of the vial.

### Example 30

The method of any of Examples 16 through 29, further comprising moving the vial along the first dimension one or more times while activating the cap engagement assembly to rotate the cap assembly about the first axis of rotation while the swab head is pressed against the inner sidewall of the vial.

### Example 31

A method comprising: removing a cap assembly from a vial, the cap assembly comprising a cap, a swab shaft extending integrally from the cap, and a swab head secured to an opposing end of the swab shaft; moving the cap relative to the vial such that the swab head is in contact with an inner side wall of the vial; and rotating the cap assembly about a first axis of rotation while the swab head is in contact with the inner sidewall of the vial.

### Example 32

The method of Example 31 further comprising deforming the swab shaft when the cap is moved relative to the vial and when the cap assembly is rotated about a first axis of rotation.

### V. Miscellaneous

While the foregoing examples are provided in the context of a system (100) that may be used in nucleotide sequencing processes, the teachings herein may also be readily applied in other contexts, including in systems that perform other processes (i.e., other than nucleotide sequencing procedures). The teachings herein are thus not necessarily limited to systems that are used to perform nucleotide sequencing processes.

It is to be understood that the subject matter described herein is not limited in its application to the details of construction and the arrangement of components set forth in the description herein or illustrated in the drawings hereof. The subject matter described herein is capable of other implementations and of being practiced or of being carried out in various ways. Also, it is to be understood that the phraseology and terminology used herein is for the purpose of description and should not be regarded as limiting. As used herein, an element or step recited in the singular and proceeded with the word “a” or “an” should be understood as not excluding plural of said elements or steps, unless such exclusion is explicitly stated. Furthermore, references to “one example” are not intended to be interpreted as excluding the existence of additional examples that also incorporate the recited features. The use of “including,” “comprising,” or “having” and variations thereof herein is meant to encompass the items listed thereafter and equivalents thereof as well as additional items.

When used in the claims, the term “set” should be understood as one or more things which are grouped together. Similarly, when used in the claims “based on” should be understood as indicating that one thing is determined at least in part by what it is specified as being “based on.” Where one thing is required to be exclusively determined by another thing, then that thing will be referred to as being “exclusively based on” that which it is determined by.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. Also, it is to be understood that phraseology and terminology used herein with reference to device or element orientation (such as, for example, terms like “above,” “below,” “front,” “rear,” “distal,” “proximal,” and the like) are only used to simplify description of one or more examples described herein, and do not alone indicate or imply that the device or element referred to must have a particular orientation. In addition, terms such as “outer” and “inner” are used herein for purposes of description and are not intended to indicate or imply relative importance or significance.

It is to be understood that the above description is intended to be illustrative, and not restrictive. For example, the above-described examples (and/or aspects thereof) may be used in combination with each other. In addition, many modifications may be made to adapt a particular situation or material to the teachings of the presently described subject matter without departing from its scope. While the dimensions, types of materials and coatings described herein are intended to define the parameters of the disclosed subject matter, they are by no means limiting and instead illustrations. Many further examples will be apparent to those of skill in the art upon reviewing the above description. The scope of the disclosed subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f) paragraph, unless and until such claim limitations expressly use the phrase “means for” followed by a statement of function void of further structure.

The following claims recite aspects of certain examples of the disclosed subject matter and are considered to be part of the above disclosure. These aspects may be combined with one another.

What is claimed is:

1. An apparatus, comprising:
a vial engagement assembly comprising a stage, the stage to releasably engage a vial;
a cap engagement assembly comprising:
a rotary shaft, and
a cap engagement head, the cap engagement head to engage a cap secured to a vial positioned in the stage of the vial engagement assembly; and
a processor, the processor to:
activate relative movement along a first dimension between the cap engagement assembly and a vial positioned in the stage of the vial engagement assembly to provide engagement between the cap engagement head and a cap secured to the vial,
activate rotation of the rotary shaft about a first rotation axis to remove the cap from the vial via the cap engagement head,
activate relative movement along a second dimension between the cap engagement assembly and the vial to provide deformation of a swab head of a swab shaft extending from the cap, the swab head deforming against an inner sidewall of the vial, and
further activate rotation of the rotary shaft to rotate the cap, swab shaft, and swab head via the cap engagement head while the swab head deforms against the inner sidewall of the vial.

2. The apparatus of claim 1, the stage of the vial engagement assembly being movable along the second dimension, the processor to activate relative movement along a second dimension between the cap engagement assembly and the vial by driving movement of the vial engagement assembly along the second dimension.

3. The apparatus of claim 1, the cap engagement head including a plurality of edges to engage material of the cap and thereby bite into the cap.

4. The apparatus of claim 3, the cap engagement head further comprising a plurality of pairs of scalloped recesses, each edge of the cap engagement head being positioned between a respective pair of scalloped recesses.

5. The apparatus of claim 3, the cap engagement head comprising a monolithic piece providing fixed separation between the plurality of edges such that the edges of the plurality of edges are immobile relative to each other.

6. The apparatus of claim 3, the edges to slide along the cap during the relative movement between the cap engagement assembly and the vial along the first dimension to provide engagement between the cap engagement head and the cap, the edges further to grip the cap during rotation of the rotary shaft to remove the cap from the vial via the cap engagement head.

7. The apparatus of claim 1, the cap engagement assembly further to pivot about a pivot axis, the pivot axis being orthogonal to the first dimension and the second dimension.

8. The apparatus of claim 7, the cap engagement assembly to pivot about the pivot axis during and after relative movement along the second dimension between the cap engagement assembly and the vial.

9. The apparatus of claim 8, the rotary shaft to rotate about a second rotation axis to thereby rotate the cap, swab shaft, and swab head via the cap engagement head while the swab head deforms against the inner sidewall of the vial.

10. The apparatus of claim 9, the second rotation axis being obliquely oriented relative to the first rotation axis.

11. A method comprising:
removing a cap assembly from a vial, the cap assembly comprising a cap, a swab shaft extending integrally from the cap, and a swab head secured to an opposing end of the swab shaft, the act of removing the cap assembly from the vial being performed by a cap engagement assembly of an apparatus;
providing separation between the cap assembly and the vial along a first dimension, the swab head remaining within an interior of the vial after the act of providing separation between the cap assembly and the vial along the first dimension, the act of providing separation between the cap assembly and the vial along the first dimension being performed by the apparatus;
providing separation between the cap assembly and the vial along a second dimension, the act of providing separation between the cap assembly and the vial along the second dimension resulting in the swab head being pressed against an inner sidewall of the vial, the act of providing separation between the cap assembly and the vial along the second dimension being performed by the apparatus; and
activating the cap engagement assembly to rotate the cap assembly about a first axis of rotation while the swab head is pressed against the inner sidewall of the vial.

12. The method of claim 11, the act of removing the cap assembly from the vial comprising:
translating the cap engagement assembly along a second dimension until the cap is received in a cap engagement head of the cap engagement assembly, and
rotating the cap engagement assembly to unscrew the cap from the vial.

13. The method of claim 12, the cap engagement head comprising a plurality of gripping edges that slide along an exterior of the cap during the act of translating the cap engagement assembly along the second dimension, the gripping edges biting into the cap during the act of rotating the cap engagement assembly to unscrew the cap from the vial, the gripping edges maintaining a fixed distance relative to each other throughout performance of the acts of translating the cap engagement assembly along the second dimension until the cap is received in a cap engagement head of the cap engagement assembly and rotating the cap engagement assembly to unscrew the cap from the vial.

14. The method of claim 11, the cap engagement assembly tilting about a pivot axis during performance of the act of providing separation between the cap assembly and the vial along the first dimension.

15. The method of claim 14, the act of removing the cap assembly from the vial comprising rotating the cap engagement assembly about a second axis of rotation, the first axis of rotation being obliquely oriented relative to the second axis of rotation.

16. The method of claim 11, the act of providing separation between the cap assembly and the vial along the second dimension further resulting in deformation of the swab shaft.

17. The method of claim 16, the deformed swab shaft resiliently urging the swab head against the inner sidewall of the vial.

18. The method of claim 11, the activating the cap engagement assembly to rotate the cap assembly about the first axis of rotation while the swab head is pressed against the inner sidewall of the vial comprising:
rotating the cap assembly in a first angular direction about the first axis of rotation while the swab head is pressed against the inner sidewall of the vial, and
rotating the cap assembly in a second angular direction about the first axis of rotation while the swab head is pressed against the inner sidewall of the vial.

19. The method of claim 18, further comprising moving the vial along the first dimension one or more times between performance of the act of rotating the cap assembly in a first angular direction about the first axis of rotation while the swab head is pressed against the inner sidewall of the vial and the act of rotating the cap assembly in a second angular direction about the first axis of rotation while the swab head is pressed against the inner sidewall of the vial.

20. A method comprising:
removing a cap assembly from a vial, the cap assembly comprising a cap, a swab shaft extending integrally from the cap, and a swab head secured to an opposing end of the swab shaft;
moving the cap relative to the vial such that the swab head is in contact with an inner side wall of the vial; and
rotating the cap assembly about a first axis of rotation while the swab head is in contact with the inner sidewall of the vial.
